(19) United States
(12) Patent Application Publication
(10) Pub. No.: US 2003/0130133 A1
(43) Pub. Date: Jul. 10, 2003

(54) Well treatment fluid

(76) Inventor: Daniel Patrick Vollmer, Lafayette, LA (US)

Correspondence Address: BAKER BOTTS, LLP, 910 LOUISIANA, HOUSTON, TX, 77002-4995, US

(21) Appl. No.: 10/316,381

(22) Filed: Dec. 11, 2002

Related U.S. Application Data
(62) Division of application No. 09/676,396, filed on Sep. 29, 2000.
Application No. 09/676,396 is a continuation-in-part of application No. 09/226,682, filed on Jan. 7, 1999, now Pat. No. 6,489,270.

(51) Int. Cl. C09K 7/00

(52) U.S. Cl. 507/100

(57) ABSTRACT

This invention relates to a wellbore treatment fluid and a method of enhancing wellbore treatment fluids to increase efficiency and productivity of wells. More specifically this invention provides methods for enhancing the thermal stability of wellbore treatment fluids such as drill-in, completion, workover, packer, well treating, testing, spacer or hole abandonment fluids. The methods include providing a wellbore treatment fluid that comprises polyol, polysaccharide, weighting agent, and water, wherein the fluid is solids free.

### RELATED APPLICATIONS

This application is a divisional of U.S. Ser. No. 09/676,396 filed Sep. 29, 2000, which is a continuation-in-part of U.S. Ser. No. 09/226,682 filed Jan. 7, 1999. This application is also related to two continuations of U.S. Ser. No. 09/226,682, filed on Sep. 21, 2000.

### FIELD OF THE INVENTION

This invention relates to the exploitation of subterranean formation using drilling, drill-in, completion, work-over, packer, well treating, testing, spacer, fluid loss control or hole abandonment fluids. More specifically, this invention is directed to a method of enhancing wellbore treatment fluids, particularly fluids used in deep wells, by enhancing the thermal stability of the treatment fluid. A fluid for use in the present invention preferably comprises water, a weighting agent, a viscosifier and a solvent. The solvent, which includes a polyol, e.g., a glycerol, glycol or polyglycol, provides a medium that increases fluid viscosity, dissolves a variety of weighting agents and enhances the thermal stability of the fluid. The fluid optionally includes surfactants, buffering agents, filter control agents, and weight-up agents.

### BACKGROUND OF THE INVENTION

There are several different types of drilling fluids used in the exploitation of subterranean formations; each fluid is specifically prepared for a particular drilling operation or wellbore environment. All drilling fluids contain additives to impart desired physical and/or chemical characteristics to the fluid. Typically the fluids contain Theological additives, fluid loss control additives and weighting agents (either dissolved or suspended solids). The Theological additives include lubricants, viscosifiers, and clayey material to lubricate the drill bit, drill string and related equipment. In addition to lubricating drill bits, drill string and related equipment, the viscosifiers and clayey material also serve to suspend solids and help “float” cutting debris out of the wellbore. Viscosifiers can also be classified as fluid loss control additives. However, fluid loss control additives also include bridging agents and/or sized particles to prevent loss of the fluid to the neighboring formation. When used as a fluid loss control agent, viscosifiers provide a fluid with sufficient viscosity to inhibit seepage of the fluid into the subterranean strata. Weighting agents typically include salts such as barite (barium sulfate), sodium bromide, sodium chloride, potassium chloride, calcium chloride, calcium bromide, zinc bromide and mixtures of these salts. The weighting agents provide the fluid with sufficient density so the hydrostatic pressure of the dense fluid in the wellbore counterbalances pressure exerted by the fluid in the strata. An optimum fluid provides constant lubricity under the high shear conditions generated by the rotating drill bit, is sufficiently viscous to prevent fluid loss into the formation, suspends solids and “floats up” or removes the debris from the wellbore.

It is difficult to maintain a fluid having the desired lubricity and viscosity under the extreme shear, pressure and temperature variances encountered during drilling operations, especially when drilling very deep wells that descent 15,000 to 30,000 feet (4,500 to 10,000 meters) or more below the earth's surface. Under these conditions many of the viscosifying agents, particularly polysaccharides such as starch, cellulose, galactomannan gums and polyacrylates, are not stable at such high temperatures and tend to un-crosslink and de-polymerize, thus losing their effectiveness. The degraded polysaccharides can cause the drill string to bind in the wellbore and induce formation damage. Thus, there is a need to enhance thermal stability of drill fluids, especially fluids that include polysaccharide based viscosifiers.

Current trends of drilling increasingly deeper wells in search of additional reserves of oil, gas and other resources require new methods of enhancing the thermal stability of the drilling fluids and preferably also reducing fluid loss into the surrounding strata.

In March of 1999, OSCA, Inc. provided a well treatment fluid to a customer of 25% propylene glycol, 75% water, 3 ppb carboxymethyl hydroxy propyl guar and enough sodium formate to obtain a density of 9.0 pounds per gallon.

In August of 1999, OSCA, Inc. provided a well treatment fluid to a customer of 20% ethylene glycol, 80% water, 3 ppb carboxymethyl hydroxy propyl guar and enough sodium formate to obtain a density of 9.0 pounds per gallon.

U.S. Pat. No. 6,103,671 discloses a method to enhance the thermal stability of a aqueous base well drilling and servicing fluid comprising adding amorphous silica (such as fumed silica) to a fluid comprising a biopolymer viscosifier, a water soluble polyalkylene glycol shale control agent and an optional salt.

U.S. Pat. 5,876,619 discloses fluid comprising scleroglucan in polyol base fluid for use as thermal insulation material.

### SUMMARY OF THE INVENTION

Thus, there is provided in accordance with the present invention a method of enhancing the thermal stability of a fluid for drilling, drill-in, completion, work-over, packer, well treating, testing, spacer, or fluid loss control that includes polymers such as polysaccharides. The method includes providing said fluid that includes water, a polyol, a viscosifying agent and a weighting agent. This fluid for drilling, drill-in, completion, work-over, packer, well treating, testing, spacer, or fluid loss control is added to the wellbore and preferably a polyol concentration of greater than about 15 wt % based on the fluid is maintained in the wellbore. The fluid is particularly useful in very deep wells that exert extreme pressure and temperature on wellbore treatment fluids. Use of this fluid for drilling, drill-in, completion, work-over, packer, well treating, testing, spacer, or fluid loss control provides a fluid that does not significantly change viscosity under the extreme conditions found in very deep wells. Furthermore, use of said fluid provides a fluid that inhibits stress cracking and pitting corrosion on the carbon and stainless steel components of the drill strings, well-drilling and related fluid handling equipment.

Accordingly, one object of the present invention is to provide a method of enhancing the thermal stability of a wellbore treatment fluid that includes a polymeric viscosifying agent.

Further objects, features, aspects, forms, advantages and benefits of the present invention shall be apparent from the description contained herein.

### BRIEF DESCRIPTION OF THE DRAWINGS

FIG. 1 is a graph illustrating the viscosity at various temperatures of a fluid containing polyethylene glycol prepared according to the present invention.

FIG. 2 is a graph illustrating the viscosity at various temperatures of 12.5 ppg fluids containing ethylene glycol or glycerol prepared according to the present invention.

FIG. 3 is a graph illustrating the viscosity at various temperatures of 13.0 ppg fluids containing a viscosifying agent with and without added glycerol.

FIG. 4 is a graph illustrating the amount of fluid loss of three 11.7 ppg calcium bromide containing fluids over 24 hours at 310° F.

### DETAILED DESCRIPTION OF THE INVENTION

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

Generally the present invention is directed toward a method of increasing the efficiency and productivity of wells, particularly deep wells, by enhancing the thermal stability of fluids for drilling, including drill-in, completion, work-over, packer, well treating, testing, spacer, or fluid loss control, and preferably also reducing loss of said fluids to the surrounding strata. The method includes adding a fluid composition that contains water, a polyol, a viscosifier and weighting agents to a wellbore and maintaining a polyol concentration in the fluid greater than about 20 wt % based upon the total weight of the fluid. The polyol can be glycerol, glycol or polyglycol.

The fluid for use in this invention is useful by itself or as a base fluid that can be combined with additives for use in a variety of wellbore treatment fluids such as drilling, drill-in, completion, fluid-loss pill, work-over, packer, well treating, testing, hydraulic fracturing, spacer or hole abandonment fluids. A wide variety of weighting agents can be used with the present invention and include a number of salts and minerals. The viscosifier for use in the fluid is a polysaccharide; however, other materials, such as, for example, clayey materials, which impart viscosity to fluids, can be used in addition to the polysaccharide viscosifying agents. The clayey materials would typically be present at up to about 5 weight %, preferably between about 1 to 5 weight %. In addition to the components listed above, the fluid can include a variety of additives to enhance physical and chemical properties exhibited by the fluid. The additional additives include fluid loss control agents, bridging agents, sized particles, pH control agents (or buffers), corrosion inhibitors, lubricants, surfactants, co-solvents and weight-up agents.

Importantly, the fluid prepared according to the present invention for use in drilling, including drill-in, completion, work-over, packer, well treating, testing, spacer, or fluid loss control, provides a dense fluid that exhibits stable rheological properties, especially at elevated temperatures and over extended periods of time. In addition, said fluid is compatible with a wide range of subterranean geological formations, formation fluids and wellbore treatment fluids to reduce formation damage and increase well production. Thus, the fluid, which is thermally stable and retains its viscosity even when used under extreme conditions such as high pressure and temperature, is particularly useful as a completion fluid in very deep wellbores.

The fluid preferably comprises both aqueous and non-aqueous fluid components. The fluid components help lubricate the drill string. They also function as a medium that dissolves a wide variety of salts and other components in the fluid. In addition, the fluid suspends components such as clayey material, drill cuttings and certain sized particles. The fluid by itself or with the addition of viscosifying agents and/or fluid loss control agents reduces fluid loss to the surrounding formation.

The aqueous component of the fluid includes water. The water may be present as a brine. The brine may be saturated or unsaturated brine. By saturated brine, it is understood that the brine is saturated with at least one salt. The water or brine can be added to the fluid either before or after the addition of any other component or additive, including the polyol. The water preferably comprises up to about 99 weight % of the fluid, based upon the weight of the fluid, preferably about 20 to about 99 weight % of the fluid, more preferably about 20 to about 85 weight %, even more preferably about 25 to about 75 weight %, even more preferably about 25 to about 50 weight %. Alternatively, the aqueous component can be included as part of the water of hydration that is commonly associated or incorporated in many of the salts that are used as weighting agents or weight-up agents.

The non-aqueous component of the fluid preferably includes a polyol. The polyol is preferably selected from the group consisting of glycerol, glycol and polyglycols, and mixtures thereof. The polyol component of the fluid can be described according to the amount it composes the fluid in wt % based upon the total weight of the fluid. Therefore, the fluid preferably comprises about up to about 99 wt % of the polyol, preferably, the fluid comprises about 15 to about 99 wt % of the polyol, even more preferably the fluid comprises about 25 to about 85 wt % of the polyol, even more preferably the fluid comprises about 25 to about 75 wt % of the polyol.

In one embodiment of the present invention, the fluid is substantially free of water. Preferably, the fluid contains about 0.5 wt % to about 10 wt % water.

The non-aqueous component of the fluid can be selected from a variety of polyols. Preferably the polyols are selected from the group consisting of glycerol, glycol, polyglycol and mixtures thereof. The glycols include commonly known glycols such as ethylene glycol, propylene glycol and butylene glycol. The polyglycols can be selected from a wide range of known polymeric polyols that include polyethylene glycol, poly(1,3-propanediol), poly(1,2-propanediol), poly(1,2-butanediol), poly(1,3-butanediol), poly(1,4-butanediol), poly(2,3-butanediol), co-polymers, block polymers and mixtures of these polymers. A wide variety of polyglycols is commercially available. Most commercially available polyglycols include polyethylene glycol, and are usually designated by a number that roughly corresponds to the average molecular weight. Examples of useful commercially available polythylene glycols include polyethylene glycol 600, polyethylene glycol 1000, polyethylene glycol 1500, polyethylene glycol 4000 and polyethylene glycol 6000. Preferably the polymeric polyols for use in the present invention are selected to have a number average molecular weight, Mₙ, of about 150 to about 18,000 Daltons. More preferably, the polymeric polyols are selected to have number average molecular weight of about 190 to about 10,000 D. Yet most preferably, the polymeric polyols are selected to have number average molecular weight of about 500 to about 7,000 D.

Polyglycols with a molecular weight of about 1000 are freely soluble in water. But as the molecular weight of the polyol increases, its water solubility decreases. Very high molecular weight polyols can be used in the present invention. However, phase separation may occur when the fluid includes the high molecular weight polyols, water and brine. An emulsifier or a surfactant can be employed to ensure that a biphasic fluid maintains fluid consistency or homogenity. Any of the emulsifying agents and surfactants commonly known and used in the art can be used in the present invention. Specific examples include: Alkoxylated lanolin oil, Castor oil ethoxylate, Diethylene glycol monotallowate, Ethoxylated fatty alchols, Ethoxylated nonylphenol, Glyceryl tribehenate, Polyglycery 1-3 diisostearate and Tallow amine ethoxylates.

Use of polyglycols having the described number average molecular weight in the present invention provides a fluid that exhibits stable Theological properties especially at elevated temperatures and over extended periods of time. These polyglycols are particularly well suited to be used in wellbore treatment fluids such as completion fluids and fluid loss pills for deep wellbores that exert high temperature and pressures on fluids.

The inclusion of polyols having a chain length greater than about 16 glycol monomeric repeating units, or a polymer composition exhibiting a number average molecular weight greater than about 1,000 up to about 18,000 dramatically increases the viscosity of the fluid. A variety of polymers can be used in fluids to increase the viscosity of the fluid in a “normal wellbore” typically less than 10,000 ft. deep (3050 m). However, most polymers do not provide the same viscosifying influence in very deep wells. Specific polyols, for example, polyols having a molecular weight of about 18,000 used in accordance with the present invention can maintain a viscosity of greater than about 180 cp at about 425° F. (218° C.) at 511 sec⁻¹ shear rate.

The fluid of the present invention also includes a weighting agent. The weighting agent can be selected from any of the known or commonly used agents to increase the density of drilling or completion fluids. Examples of useful weighting agents include monovalent and divalent salts, preferably alkali metal salts and or alkaline earth metal salts. Typically the weighting agents include cations selected from alkali metal, alkaline earth metal, ammonium, manganese, zine cations, and anions selected from halides, oxides, carbonates, nitrates, sulfates, acetates and formate anions. Preferred weighting agents include alkaline earth metal salts and or alkali metal salts, preferably alkali metal formates, alkaline earth metal formates, alkaline earth metal halides and or alkali metal halides. Particularly preferred weighting agents include potassium chloride, sodium chloride, sodium bromide, calcium chloride, calcium bromide, zinc bromide, zinc formate, zinc oxide, sodium formate, sodium acetate, sodium bromide and mixtures of these salts.

Weighting agents are used to increase the fluid density so the hydrostatic pressure exerted by the fluid in the wellbore balances the formation fluid pressure at the desired well depth. Thus, the weighting agent is added to the fluid to provide a fluid having a density of about 7 to about 20 pounds per gallon (ppg) (0.84 to 2.40 g/ml). More preferably, the fluid comprises an amount of the weighting agent sufficient to provide a fluid having a density of about 9 to about 17 ppg (1.08 to 2.04 g/ml). More preferably, the fluid comprises an amount of the weighting agent sufficient to provide a fluid having a density of about 9.0 to about 14 ppg (1.08 to 1.68 g/ml).

In one embodiment the fluid may also comprise one or more alcohols. Preferred alcohols include methanol, ethanol, propanol, isopropanol, butanol, isobutanol, t-butanol and other C₅ to C₂₀ alcohols. In some embodiments the alcohol may comprise a majority of the fluid. For example, a fluid comprising methanol, polyol, water and polysaccharide would be a useful fluid of this invention. The alcohols may be present at up to 95 weight % and in some embodiments are present at 50 to 95 weight %.

In one embodiment of the present invention, the fluid comprises a sufficient amount of at least one weighting agent to saturate the solvent. Preferably the fluid of the present invention comprises about 1 to about 84 wt % of the weighting agent; more preferably, about 10 to about 60 wt %; most preferably about 25 to about 50 wt % of the weighting agent based upon the total weight of the fluid.

The aqueous and/or non-aqueous components of the fluid of the present invention provide a medium that readily dissolves a variety of additives, particularly polymers used as viscosifying agents. Often polymers decompose because of the extreme conditions in deep wellbores. It has been determined when a fluid includes a polyol as a solvent component as disclosed in the present invention the polysaccharide viscosifiers, such as starch, cellulose, galactomannan gums, polyacrylates and biopolymers, which also are included in the fluid, exhibit enhanced thermal stability. Furthermore, the polyols provide a fluid or solvent that is compatible with clayey material that can be added to wellbore treatment fluids, particularly drill-in fluids.

The fluid of the present invention can comprise a viscosifier as about 0.1 to about 5 wt % of the fluid, preferably about 0.5 to about 4 weight %, even more preferably about 1 to about 3 weight %. Any of the known and/or commonly used viscosifiers in the art are useful in the present invention. The viscosifier can be selected from a wide variety of polymers: Typical polymers include anionic or nonionic polysaccharides, such as cellulose, starch, galactomannan gums, polyvinyl alcohols, polycarylates, polyacrylamides and mixtures thereof. Cellulose and cellulose derivatives include alkylcellulose, hydroxyalkyl cellulose or alkylhydroxyalkyl cellulose, carboxyalkyl cellulose derivatives such as methyl cellulose, hydroxyethyl cellulose, hydroxypropyl cellulose, hydroxybutyl cellulose, hydroxyethylmethyl cellulose, hydroxypropylmethyl cellulose, hydroxylbutylmethyl cellulose, methyldydroxyethyl cellulose, methylhydroxypropyl cellulose, ethylhydroxyethyl cellulose, carboxyethylcellulose, carboxymethylcellulose and carboxymethylhydroxyethyl cellulose. The polysaccharides also include microbial polysaccharides such as xanthan, succinoglycan and scieroglucan. The polysaccharides include any of the known or commonly used galactomannan gums and derivatized galactomannan gums. Specific examples of polysaccharides useful with the present invention include but are not limited to guar gum, hydroxypropyl guar, carboxymethyl-hydroxypropyl guar and known derivatives of these gums. Preferred polysaccharides also include xanthan gum, and or carboxymethyl hydroxy ethyl cellulose, and or hydroxyethyl cellulose, and known derivatives. Particularly preferred polysaccharides include cellulose, carboxyalkyl hydroxy alkyl cellulose, xanthan gum, succinoglycan, scleroglucan, starch, galactomannan gums, polyvinyl alcohols, polyacrylates, polyacrylamides or mixtures thereof. Particularly preferred polysaccharides include guar gum, hydroxyalkyl guar, carboxy alkyl hydroxyalkyl guar, xanthan gum or derivatives thereof.

The fluids of the present invention typically have a viscosity of greater than about 100 cp. at about 200° F. at 511 sec⁻¹ shear rate; more preferably, the fluid has a viscosity greater than about 150 cp. at 200° F. at 511 sec⁻¹; most preferably, the fluid has a viscosity of about 200 cp. at about 200° F. at 511 sec⁻¹ shear rate. Furthermore, the fluids of the present invention exhibit viscosity greater than about 30 cp at 100 sec⁻¹ up to about 425° F. (about 218° C.).

The fluid of the present invention can include additional components to modify the rheological and chemical properties of the fluid. Clayey materials such as bentonite, attapulgite, sepiolite or other material commonly used in drilling fluids can be included in the present invention to provide drilling muds to lubricate the drill strings and suspend drill cuttings. The fluid also can include buffering agents or pH control additives. Buffering agents are used in drilling fluids to maintain the desired pH of the fluid. If the pH of the drilling fluid becomes too low, severe degradation of the included polymers, particularly the viscosifying agents, results. Typical examples of buffering agents include, but are not limited to: sodium phosphate, sodium hydrogen phosphate, boric acid-sodium hydroxide, citric acid-sodium hydroxide, boric acid-borax, sodium bicarbonate, ammonium salts, sodium salts, potassium salts, dibasic phosphate, tribasic phosphate, lime, slaked lime, magnesium oxide, basic magnesium carbonate, calcium oxide and zinc oxide.

The fluids of this invention are preferably a uniformly dispersed mixture. In a preferred embodiment the fluids of this invention do not comprise oil. Oil, if present, is present in such an amount as to have little or no affect on the fluid properties. Oil, if present, is preferably present at less than 5 weight %, more preferably less than 1 weight %, more preferably at less than 0.5 weight %. The fluids of this invention are preferably not present as an emulsion. In another embodiment the fluids of this invention comprise less than 10 weight % emulsifier or surfactant, more preferably less than 5 weight % emulsifier or surfactant, even more preferably less than 1 weight % emulsifier or surfactant. In another embodiment the fluids of this invention are solutions or suspensions of solids in a solution.

In a preferred embodiment the fluids of this invention are solids free. By solids free is meant that prior to introduction into the wellbore, the fluid contains no solids, or if solids (including but not limited to contaminants and the like) are present, they are present in such amounts that they do not significantly affect the properties of the fluid (as compared to the properties of the fluid without the solids). In a preferred embodiment, if solids are present then the solids are present at less than 5.0 weight %, preferably less than 3 weight %, more preferably less than 0.5 weight %, more preferably at less than 0.1 weight %, more preferably less than 0.075 weight %, more preferably less than 0.05 weight %, more preferably at less than 0.025 weight %, more preferably at 0.005 weight %, more preferably at less than 0.001 weight %. In another preferred embodiment, the fluid is silica free. By silica free is meant that prior to introduction into the wellbore, the fluid contains no silica, or if silica is present, it is present in such amounts that it does not significantly affect the properties of the fluid (as compared to the properties of the fluid without the silica). In a preferred embodiment amorphous silica, such as fumed silica, is present at less than 0.1 weight %, preferably less than 0.075 weight %, more preferably less than 0.05 weight %, more preferably at less than 0.025 weight %, more preferably at 0.005 weight %, more preferably at less than 0.001 weight %.

Weight % solids and weight % silica is determined by X-ray diffraction standardized upon 4 controls of 0.01 weight %, 0.1 weight %, 0.5 weight % and 1 weight % solids or silica, respectively.

Substantial temperature and pressure are encountered at well depths over 15,000 feet deep (4,500 m). At these depths the temperature often exceeds 350° F. (177° C.). Use of the fluid according to the present invention provides enhanced thermal stability for the viscosifying agents and polymeric components that are composed of polysaccharides. The fluid prepared according to the present invention maintains its viscosity under extremely high temperature, pressure and shear conditions. Thus, the fluid is especially suited for use in applications in extremely deep wellbores.

Drilling, and wellbore treatment fluids are constantly monitored to allow the operator to react to changes in the wellbore conditions and fluids as different formation strata are encountered and when drilling operations change. Thus in accordance with the present invention, the glycerol, glycol or polyglycol concentration is preferably maintained at a level greater than about 15 wt % of the total weight of the fluid, preferably greater than about 20% of the total weight of the fluid. It is understood that as the fluid is added and used in the wellbore, it will become contaminated with drill cuttings, debris, mineral and formation fluids and other material from the formation. It is important to be able to mix the fluid with additional components “on the fly” to modify the wellbore fluid while the drilling operation continues. Thus, the fluid of the present invention provides useful advantages when used as a base for a completion fluids and fluid loss pills. When the fluid of the present invention is used either by itself or in combination with other additives, the fluid has enhanced thermal stability and a reduced tendency to leak off into the formation.

For the purpose of promoting further understanding and appreciation of the present invention and its advantages, the following Examples are provided. It will be understood, however, that these Examples are illustrative and not limiting in any fashion.

### EXAMPLE 1

### Radial Fluid Loss for Newtonian Fluids

To demonstrate the effect of increased viscosity on radial fluid loss for a Newtonian fluid, the fluid loss of two solids-free weighted fluids are compared. The viscosity data for weighted fluids, which were used to simulate completion brines, were obtained from Foxenberg, W. E., et al., “Effects on Completion Fluid Loss on Well Productivity”, SPE 31137, presented at the SPE International Symposium on Formation Damage Control 14-15 February 1996, Lafayette, La., USA to be used in Eq. (1) and (2). Viscosity data for weighted fluids solutions other than completion brines were obtained from Perry and Green, Perry's Chemical Engineers' Hand book, 6th edition, 1984, p. 3-251 and 2-352.

The rate of fluid loss of both types of pills can be approximated by calculating the fluid loss of a Newtonian fluid according to the following Equation (1) as discussed in “Power-Law Flow and Hydrodynamic Behavior of Biopolymer Solutions in Porous Media”, Paper SPE 8982, Teeuw, Dirk and Hesselink, F. Theodore presented at the SPE Fifth International Symposium on Oilfield and Geothermal Chemistry, held in Stanford, Calif., May 28-30, 1980, and Lau, “Laboratory Development and Field Testing of Succinoglycan as a Fluid-Loss-Control Fluid”, SPE Drilling and Completion, December 1994, pp 221-226.

v=kP/μh (1)

In the above equation, v is the superficial velocity of fluid leaking off into the formation in cm/s, k is the permeability of the filter cake or the formation in darcies, P is the differential pressure in atmospheres, h is the filter cake thickness or the invasion depth in cm and μ is the viscosity of the fluid or filtrate in centipoise. Equation (1), which has been termed Darcy's equation, can be integrated to approximate the radial fluid loss of a Newtonian fluid from a circular wellbore to provide Equation (2).

Q=2πLkP/μln(R/r) (2)

In the above Equation, Q is the radial fluid loss from the well into the formation in cm³/s , L is the wellbore interval length in cm, k is the permeability of the filter cake or the formation in darcies, P is the differential pressure in atmospheres, μ is the viscosity of the fluid or filtrate in centipoise, R is the outer radius in cm, and r is the inner radius in cm.

For the purpose of this invention, the following equation derived by Teeuw and Hesselink will be used to model a solids-free pill's performance. (See Lau, H. C. “Laboratory Development and Field Testing of Succinoglycan as a Fluid-Loss Control Fluid,” SPE Drilling and Completion, December 1994, pp 221-226.)

v=(φn/3n+1)(8k/φ)⁽ⁿ⁺¹⁾²ⁿ(ΔP/2KL) (3)

Wherein n is the power law exponent, K is the consistency index or viscosity at 1 sec⁻¹ and φ is the porosity of a formation. For a Newtonian fluid where n is equal to 1 and K equals μ, Equation (3) reduces to Darcy's equation shown above as Equation (2). Integration of Equation (3) provides an Equation (4) as a basic equation for radial fluid loss through a porous media.

v=(φn/3n+1)(8k/φ)⁽ⁿ⁺¹⁾²ⁿ(ΔP/2KL)(1−n/r¹⁻ⁿ−r_{w}¹⁻ⁿ) (4)

In the above Equation, r is the total radius, which includes the wellbore radius and the penetration radius, of the fluid into the formation in meters and r_{w} is the wellbore radius in meters.

Equation (4) was used to calculate the radial fluid loss for a solids-free Newtonian fluid for a well that has a formation permeability of 10 md, porosity of 0.3, and bottom hole temperature of 200° F. (93° C.). A fluid density of 10.3 ppg (1.24 g/ml) is required to maintain an overbalanced pressure of 300 psig during the completion process. The well has an interval length of 100 ft (30 m), and the wellbore radius is 3 inches (7.62 cm) to require 3.5 barrels (bbl, 556 l) of fluid to fill the wellbore (one bbl contains 42 gallons of fluid or 158.8 l). At 200° F. (93° F.), 10.3 ppg (1.24 g/ml) CaCl₂ brine has a viscosity of about 1 cp. And 10.3 ppg (1.24 g/ml) glycerol based fluid has a viscosity of about 19.5 cp. In Table 2, the differences in fluid loss rate and time with invasion depth using Equation (1) are tabulated. Notice that in one hour the 10.3 ppg (1.24 g/ml) CaCl₂ brine would require about 53 bbl. (8416 l) whereas only about 9 bbl (1429 l) glycerol would be needed for fluid loss control.

TABLE 1
Radial Fluid Loss for Newtonian Fluids

| | | 10.3 ppg CaCl₂ | | 10.3 ppg Glycerol | |
|---|---|---|---|---|---|
| Invasion | Total Pill | Fluid Loss | Time | Fluid Loss | Time |
| Depth, ft. | Volume, bbl. | Bbl./hr. | Hours | bbl./hr. | Hours |
| 0.2 | 5.9 | 151 | 0.0 | 7.7 | 0.3 |
| 0.3 | 7.5 | 112 | 0.0 | 5.8 | 0.7 |
| 0.4 | 9.5 | 93 | 0.1 | 4.8 | 1.3 |
| 0.5 | 11.9 | 81 | 0.1 | 4.1 | 2.0 |
| 0.6 | 15.6 | 72 | 0.2 | 3.7 | 3.0 |
| 0.7 | 17.6 | 66 | 0.2 | 3.4 | 4.2 |
| 0.8 | 21.0 | 62 | 0.3 | 3.2 | 5.5 |
| 0.9 | 24.7 | 58 | 0.4 | 3.0 | 7.1 |
| 1.0 | 28.7 | 55 | 0.5 | 2.8 | 8.9 |
| 1.5 | 53.9 | 46 | 1.1 | 2.3 | 21.6 |

### EXAMPLE 2

### Radial Fluid Loss for a Glycerol Fluid

Using the methods described in Example 1, the fluid loss rate for a NaCl brine solution and a polyglycol solution can be compared. For a well formation that has permeability of 10 md, porosity of 0.3, and bottom hole temperature of 425° F. (218° C.), a fluid density of 9.2 ppg (1.1 g/ml) is required to maintain an overbalanced pressure of 300 psig during the completion process. The well that has an interval length of 100 ft. (30 m) and the wellbore radius of 3 inches (7.6 cm), requires 3.5 bbl (556 l) of fluid to fill the wellbore. At 425° F. (218° C.), 10.0 ppg, (1.2 g/ml) NaCl brine has a viscosity of about 0.28 cp and 8.334 ppg (1 g/ml) NaCl brine (less than 10 g/L NaCl) has a viscosity of less than 0.1 cp. Therefore, for a 9.2 ppg (1.1 g/ml) NaCl, a viscosity of 0.2 will be used. The data listed in Table 2 indicates this polyglycol based fluid controls fluid loss much better than the brine. For example, in one hour about 175 bbls (27,790 l) of fluid would be lost to formation, whereas using the glycol less than 2.5 bbl (397 l) (5.9 total bbl—3.5 bbl to fill wellbore) will be lost.

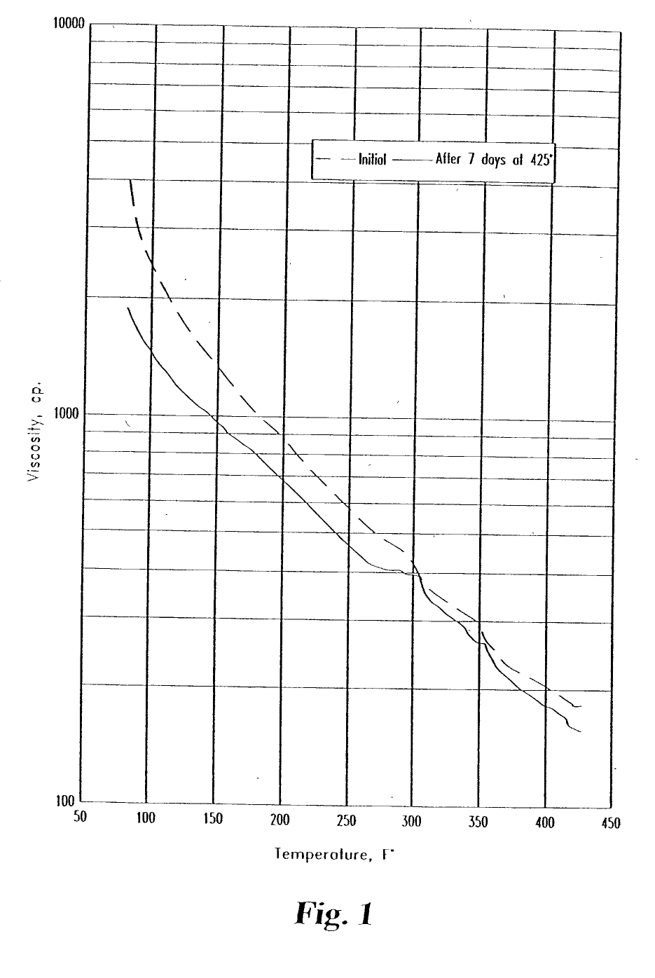

In FIG. 1 a graph illustrating the viscosity of a 9.2 ppg (1.1 g/ml) polyglycol (M.W. of 18,000 D) fluid at various temperatures is presented. The dashed line indicates the viscosity of the polyglycol fluid initially measured soon after it was prepared. The solid line indicates the viscosity of the same polyglycol fluid after the fluid had been maintained at 425° F. (218° C.) for seven days. It is readily apparent from examining the graph that the viscosity of the polyglycol fluid does not change significantly even after it has been stored at 425° F. (218° C.) for seven days.

TABLE 2

| | | 9.2 ppg NaCl | | 9.2 ppg Polyglycol | |
|---|---|---|---|---|---|
| Invasion | Total Pill | Fluid Loss | Time | Fluid Loss | Time |
| Depth, ft. | Volume, bbl. | bbl./br. | Hours | bbl./hr. | Hours |
| 0.2 | 5.9 | 753 | 0/0 | 0.8 | 2.8 |
| 0.3 | 7.5 | 561 | 0.0 | 0.6 | 6.5 |
| 0.4 | 9.5 | 463 | 0.0 | 0.5 | 11.7 |
| 0.5 | 11.9 | 403 | 0.0 | 0.5 | 18.8 |
| 0.6 | 15.6 | 362 | 0.0 | 0.4 | 27.6 |
| 0.7 | 17.6 | 332 | 0.0 | 0.4 | 38.3 |
| 0.8 | 21.0 | 308 | 0.1 | 0.3 | 51.0 |
| 0.9 | 24.7 | 290 | 0.1 | 0.3 | 65.6 |
| 1.0 | 28.7 | 275 | 0.1 | 0.3 | 82.4 |
| 1.5 | 53.9 | 223 | 0.2 | 0.3 | 199 |
| 3.0 | 179 | 173 | 1.0 | 0.2 | 919 |

### EXAMPLE 3

### Viscosity of Polyglycol Fluid with Added Hydroxypropyl Cellulose

The viscosities of a polyglycol with and without added viscosifying agents were measured and compared. One barrel (159 l) of a polyethylene glycol fluid having an average molecular weight of 200 grains/mole and sold under the trade name Polyglycol E2000 by Dow Chemical, Inc. was admixed with 5 pounds (1.9 kg) hydroxypropyl cellulose (HPC). After mixing for 1 hour at room temperature, the viscosity was measured on a variable speed rheometer at 120° F. (49° C.) and 180° F. (82° C.) under a wide range of shear conditions. The results of the viscosity measurements for both the polyglycol fluid and the polyglycol fluid with added HPC are listed in Table 3. Analysis of the results underscores the enhanced viscosity that can be achieved by the addition of a viscosifying agent. The fluids prepared according to this invention demonstrate non-Newtonian characteristics. These fluids exhibit increased viscosity at low shear rates and low viscosity at high shear rates.

TABLE 3

| | | Polyglycol E200 | | Polyglycol E200 + 5 ppb HPC | |
|---|---|---|---|---|---|
| 1022 | sec⁻¹ | 24 cp. | 11 cp. | 106 cp. | 70 cp. |
| 511 | sec⁻¹ | 24 cp. | 11 cp. | 135 cp. | 93 cp. |
| 10.2 | sec⁻¹ | — | — | 650 cp. | 550 cp. |
| 5.1 | sec⁻¹ | — | — | 900 cp. | 700 cp. |

| | | | | |
|---|---|---|---|---|
| N | 1 | 1 | 0.595 | 0.560 |
| K, cp. | 24 | 11 | 1700 | 1500 |
| PV/YP | 22/0 | 11/0 | 77/58 | 43/53 |
| Temp. ° F. | 120 | 180 | 120 | 180 |

### Example 4

### Viscosity of Sodium Bromide Brines with Added Xanthan Gum

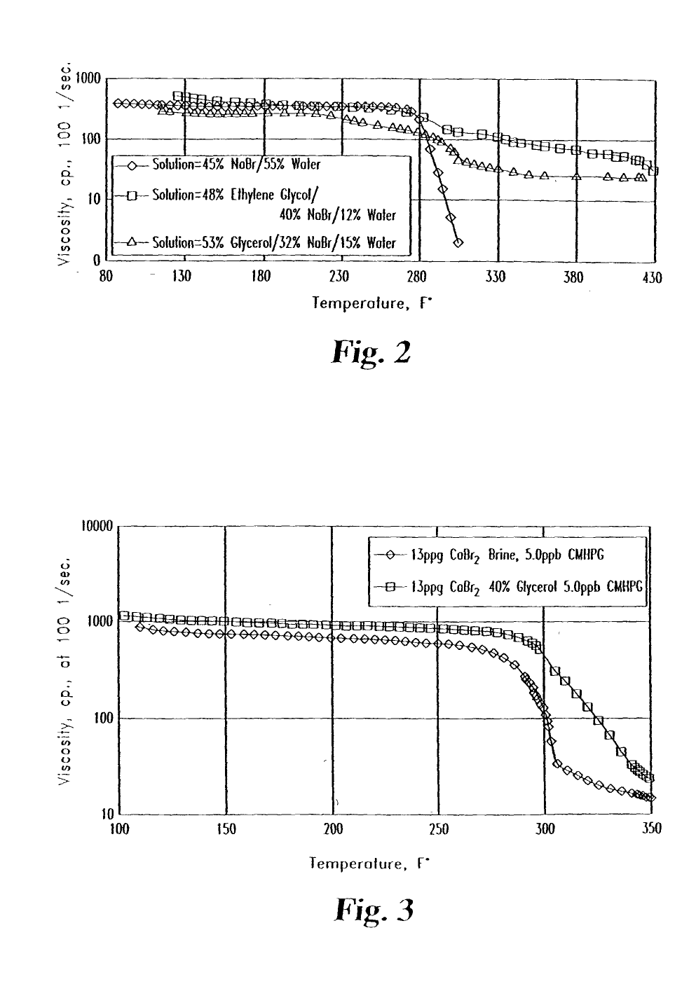

The viscosities of three different 12.5 ppg (1.5 g/ml) sodium bromide brine solutions were measured. A viscosifying agent, xanthan gum (5.0 ppb, 11.7 g/l), was added to each brine solution. The first brine solution “A” consisted of 45 wt % sodium bromide and 55 wt % water; the second brine solution “B” contained 40 wt % sodium bromide, 12 wt % water and 48 wt % ethylene glycol; and the third solution “C” contained 32 wt % sodium bromide, 15 wt % water and 53 wt % glycerol. The viscosities were measured at various temperatures ranging from 100° F. (37.8° C.)to about 350° F. (177° C.) using a Fann 50 rheometer. The results are graphically illustrated in FIG. 2. The viscosity of all three brine solutions remained relatively constant at above 300 cp. up to about 270° F. (132° C.). However, above 270° F. (132° C.) brine solution “A”; which contained only sodium bromide, water and the viscosifying agent, dropped significantly. At about 300° F. (149° C.) the viscosity of this solution was only about 5 cp; above 300° F. (149° C.) the viscosity approached 0 cp. The viscosity of brine solution “C”, which contained ethylene glycol, remained above 100 cp at about 330° F. (165° C.). Thus, by incorporating ethylene glycol or glycerol into the brine solution and maintaining a density of 12.5 ppg (1.5 g/ml), the viscosity of the fluids can be maintained above 100 cp. up to 350° F. (177° C.) and above 30 cp. up to 425° F. (218° C.) (see FIG. 2).

EXAMPLE 5

Viscosity of Calcium Bromide Brines with Added Carboxymethyl Hydroxypropyl Guar

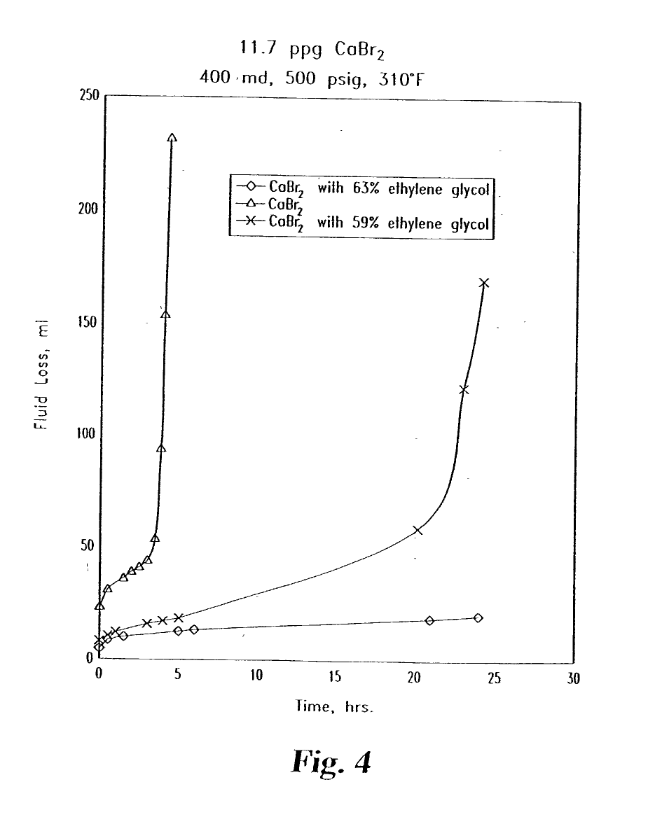

The viscosities of two 13.0 ppg (1.56 g/ml) calcium bromide solutions each containing 5.0 ppb (11.7 g/l) carboxymethyl hydroxypropyl guar (CMHPG) were measured at various temperatures using a Fann 50 rheometer. Solution “D” contained calcium bromide, water and CMHPG; while solution “E” contained calcium bromide, water, glycerol, and CMHPG. The results are graphically illustrated in FIG. 3. The viscosity of both solutions remained above about 300 cp. up to about 285° F. (140° C.). The viscosity of solution D, which contained calcium bromide and water, dropped to less than 100 cp. above 300° F. (149° C.). However, the viscosity of solution “E”, which contained glycerol, maintained a viscosity above 300 cp up to about 300° F. (149° C.). By incorporating 40% by weight glycerol and maintaining a density of 13.0 ppg (1.56 g/ml) the viscosity of the fluid remained above 300 cp. up to about 320° F. (160° C.) which is a 35° F. (11° C.) improvement over the solution that did not include glycerol.

EXAMPLE 6

Enhanced Thermal Stability of Polyol Based Fluids

An aqueous fluid including 5 ppb (11.7 g/l) of carboxymethyl cellulose in water was compared to a polyol based fluid. The polyol based fluid contained 5 ppb (11.7 g/l) of carboxymethyl cellulose dissolved in 75% by volume ethylene glycol and 25% by volume water based upon the total volume of the fluid. The initial viscosity, measured according to the procedure described in Example 5 at 100 s⁻¹ and at 120° F. (49° C.), of the aqueous fluid was 825 cp. and the polyol based fluid had a viscosity of 1,316 cp measured under the same conditions.

After heat aging the two solutions at 275° F. (135° C.) for 16 hours, the viscosity of the aqueous based fluid decreased to 2 cp.; while the viscosity of the polyol based fluid only decreased to 261 cp. Thus, the use of a polyol based fluid provides an increased stability of the viscosity of the fluids.

EXAMPLE 7

Polyol Based Viscosified Wellbore Insulating Fluid

An 9.0 ppg aqueous fluid system including 25% propylene glycol, 75% water and enough sodium formate to achieve a 9.0 ppg density contained 3 ppb (7 g/l) of carboxylmethyl hydroxypropyl guar (CmHPG). This formulation produced a fluid with a viscosity of 185 cp when measured at 72° F. and 300 rpm. Heat flow studies with this fluid formulation resulted in a Heat Flux value of 405 BTU/hr·ft², which reduced the heat transfer by more than 80% when compared with the base brine. The Heat Coefficient was calculated to be 5.0 BTU/hr·ft²·° F., as determined in a concentric wellbore model with a 1.6 inch I.D. tubing inside a 4.7 inch (ID) casing.

EXAMPLE 8

Polyol Based Viscosified Wellbore Insulating Fluid

An 10.5 ppg aqueous fluid including 25.0% propylene glycol, 11.4% water, 63.5% 11.6 ppg CaCl₂ was formulated to contain 3 ppb (7 g/l) hydroxy ethyl cellulose. The viscosity of this fluid was measured to be 200 cp at 72° F. and 300 rpm.

EXAMPLE 9

Polyol Based Viscosified Wellbore Insulating Fluid

An 11.5 ppg aqueous fluid including 25% propylene glycol, 55.7% 11.6 ppg CaCl₂ and 19.8% 15.1 ppg CaBr₂/CaCl₂ was formulated to contain 3 ppb (7 g/l) hydroxyl ethyl cellulose. The viscosity of this fluid was measured to be 190 cp at 72° F. and 300 rpm.

EXAMPLE 10

Polyol Based Viscosified Wellbore Insulating Fluid

An 12.7 ppg aqueous fluid including 25.0% ethylene glycol, 27.9% 11.6 ppg CaCl₂, and 47.1% 15.1 ppg CaCl₂/CaBr₂ was formulated to contain 3 ppb (7 g/l) hydroxyl ethyl cellulose. The viscosity of this fluid was measured to be 184 cp at 70° F. and 300 rpm.

EXAMPLE 11

Polyol Based Viscosified Wellbore Insulating Fluid

An 13.5 ppg aqueous fluid including 20% ethylene glycol, 5% water, 73% 15.1 ppg CaCl₂/CaBr₂ containing 3 ppb (7 g/l) hydroxy ethyl cellulose (HEC) for use as a thermal insulating fluid system. The viscosity of this fluid system was measured at 310 cp at 72° F. and 300 rpm.

All documents described herein are incorporated by reference herein, including any priority documents and/or testing procedures. As is apparent form the foregoing general description and the specific embodiments, while forms of the invention have been illustrated and described, various modifications can be made without departing from the spirit and scope of the invention. Accordingly it is not intended that the invention be limited thereby.

What is claimed:

1. A method for insulating a wellbore comprising the steps of:
providing a well treatment fluid composition in said wellbore, said well treatment fluid composition having a minimum viscosity of over 100 cp. at about 70° F. and 300 rpm and comprising:
a) a polyol,
b) a polysaccharide,
c) a weighting agent, and
d) water,
wherein the fluid composition is silica free and the fluid composition is not an emulsion;
subjecting the well treatment fluid composition to high pressure, temperature and/or heat, wherein said well treatment composition maintains said minimum viscosity; and
reducing heat transfer in said wellbore.

2. The method of claim 1 wherein the polyol is present at about 15 to about 99 weight %, based upon the weight of the fluid composition.

3. The method of claim 1 wherein the polysaccharide is present at about 0.5 to about 5 weight %, based upon the weight of the fluid composition.

4. The method of claim 1 wherein the weighting agent is present at about 1 to about 84 weight %, based upon the weight of the fluid composition.

5. The method of claim 1 wherein the weighting agent is present at about 10 to about 60 weight %, based upon the weight of the fluid composition.

6. The method of claim 1 wherein the weighting agent is present at about 25 to about 50 weight %, based upon the weight of the fluid composition.

7. The method of claim 1 wherein the polyol is selected from the group consisting of glycerol, a glycol, a polyglycol, and mixtures thereof.

8. The method of claim 1 wherein the polyol is selected from the group consisting of polyethylene glycol, poly(1,3-propanediol), poly(1,2-propanediol), poly(1,2-butanediol), poly(1,3-butanediol), poly(1,4-butanediol), poly(2,3-butanediol), and mixtures thereof.

9. The method of claim 1 wherein the polyol comprises ethylene glycol, propylene glycol and/or butylene glycol.

10. The method of claim 1 wherein the polyol has a number average molecular weight of about 150 to about 18,000.

11. The method of claim 1 wherein the polyol has a number average molecular weight of about 190 to about 10,000.

12. The method of claim 1 wherein the polyol has a number average molecular weight of about 500 to about 7,000.

13. The method of claim 1 wherein the polyol comprises one or more polyethylene glycols having a number average molecular weight of about 150 to about 18,000.

14. The method of claim 1 wherein the polysaccharide comprises cellulose, carboxyalkyl hydroxy alkyl cellulose, xanthan gum, succinoglycan, scleroglucan, starch, galactomannan gums, polyvinyl alcohols, polyacrylates, polyacrylamides or mixtures thereof.

15. The method of claim 1 wherein the polysaccharide comprises alkyl cellulose, hydroxyalkyl cellulose, alkylhydroxyalkyl cellulose and/or carboxyalkyl cellulose derivatives.

16. The method of claim 1 wherein the polysaccharide comprises galactomannan gums, xanthan gums and/or derivatized galactomannan gums.

17. The method of claim 1 wherein the polysaccharide comprises guar gum, hydroxyalkyl guar, carboxy alkyl hydroxyalkyl guar, xanthan gum or derivatives thereof.

18. The method of claim 1 wherein the weighting agent comprises monovalent and/or divalent salts.

19. The method of claim 1 wherein the weighting agent comprises an alkali metal salt or an alkaline earth metal salt.

20. The method of claim 1 wherein the weighting agent comprises a cation selected from the group consisting of alkali metals, alkaline earth metals, ammonium, manganese and zinc cations, and an anion selected from the group consisting of halides, oxides, carbonates, nitrates, sulfates, acetates and formate anions.

21. The method of claim 20 wherein the anion comprises a formate anion and/or a halide anion and the cation comprises an alkali metal cation.

22. The method of claim 20 wherein the anion comprises a halide anion and the cation comprises an alkaline earth metal cation and/or an alkali metal cation.

23. The method of claim 1 wherein the weighting agent comprises CaCl₂, NaCl, NaBr and/or CaBr₂.

24. The method of claim 1 wherein the weighting agent comprises KCl, KBr, K(CHO₂), K(CH₃CO₂), NaCl, NaBr, Na(CHO₂), Na(CH₃CO₂), CaCl₂, CaBr₂, ZnBr₂, ZnCl₂, Cs(CHO₂), Cs(CH₃CO₂), ZnO or mixtures thereof.

25. The method of claim 1 wherein
the polyol comprises propylene glycol and/or ethylene glycol,
the weighting agent comprises an alkali metal salt, and
the polysaccharide comprises carboxymethyl hydroxyl propyl guar, and/or xanthan gum, and/or carboxymethyl hydroxy ethyl cellulose, and/or hydroxyethyl cellulose, and/or hydroxy propyl guar.

26. The method of claim 1 wherein
the polyol comprises propylene glycol and/or ethylene glycol,
the weighting agent comprises CaCl₂ and/or CaBr₂, and
the polysaccharide comprises hydroxyethyl cellulose, and/or hydroxy propyl guar, and/or xanthan gum, and/or carboxymethyl hydroxyl propyl guar and/or carboxy methyl hydroxy ethyl cellulose.

27. The method of claim 1 wherein the fluid composition has a density of from about 7.0 pounds per gallon to about 20 pounds per gallon.

28. The method of claim 1 wherein the fluid composition has a density of from about 9.0 pounds per gallon to about 14 pounds per gallon.

29. The method of claim 25 wherein the polyol is present at about 15 to about 99 weight %, the weighting agent is present at about 1 to about 84 weight %, and the polysaccharide is present at about 0.5 to about 5 weight %, based upon the weight of the fluid composition.

30. The method of claim 26 wherein the polyol is present at about 15 to about 99 weight %, the weighting agent is present at about 1 to about 84 weight %, and the polysaccharide is present at about 0.5 to about 5 weight %, based upon the weight of the fluid composition.

31. The method of claim 1 wherein said composition comprises:
about 25 to about 85 weight % water,
about 15 to about 75 weight % of propylene glycol and/or ethylene glycol,
about 1 to about 84 weight % of an alkali metal salt, and
about 0.5 to about 5 weight % of carboxymethyl hydroxyl propyl guar, xanthan gum and/or carboxymethyl hydroxyalkyl cellulose, based upon the weight of the fluid composition,
wherein the fluid composition has a density of about 9.0 ppg to about 20 ppg.

32. The method of claim 1 wherein said fluid composition comprises:
about 25 to about 85 weight % water,
about 15 to about 75 weight % of propylene glycol and/or ethylene glycol,
about 1 to about 84 weight % of an alkaline earth metal salt, and
about 0.5 to about 5 weight % of carboxymethyl hydroxyl propyl guar, xanthan gum and/or carboxymethyl hydroxyalkyl cellulose, based upon the weight of the fluid composition,
wherein the fluid composition has a density of about 9.0 ppg to about 20 ppg.

33. The method of claim 1 wherein the water is present at about 25 to about 99 weight %, based upon the weight of the fluid composition.

34. The method of claim 1 wherein the water is present at up to 99 weight %, based upon the weight of the fluid composition.

35. The method of claim 1 wherein the water is a brine.

36. The method of claim 1 wherein the fluid composition comprises less than 0.1 weight % solids.

37. The method of claim 1 wherein the fluid composition comprises less than 1 weight % emulsifier or surfactant.

38. The method of claim 1 wherein the fluid composition is solids free.

39. The method of claim 1 further comprising up to 5 wt % clayey material.

40. The method of claim 1 wherein the fluid composition is a solution.

41. The method of claim 1 wherein the fluid composition is a suspension of a solid in a solution.

42. A method for insulating a wellbore comprising the steps of:
providing a well treatment fluid composition in said wellbore, said well treatment fluid composition having a minimum viscosity of over 100 cp. at about 70° F. and 300 rpm and comprising:
a) a polyol,
b) a polysaccharide,
c) a weighting agent, and
d) water,
wherein the fluid composition is silica free and the fluid composition is a solution;
subjecting the well treatment fluid composition to high pressure, temperature and/or heat, wherein said well treatment composition maintains said minimum viscosity; and
reducing heat transfer in said wellbore.

43. The method of claim 42 wherein the fluid composition is a solution having up to about 5 weight % clayey materials suspended in the solution.
